(19) United States
(12) Patent Application Publication
(10) Pub. No.: US 2018/0071792 A1
(43) Pub. Date: Mar. 15, 2018

(54) HIGH-PRESSURE CLEANING SYSTEM AND DISCHARGE UNIT FOR SUCH A HIGH-PRESSURE CLEANING SYSTEM

(71) Applicant: Alfred Kärcher GmbH & Co. KG, Winnenden (DE)

(72) Inventors: Timo Spengler, Weil der Stadt (DE); Sven Dirnberger, Steinheim (DE); Gottfried Benzler, Kirchberg (DE); Manuel Berroth, Lorch (DE)

(21) Appl. No.: 15/817,932

(22) Filed: Nov. 20, 2017

Related U.S. Application Data
(63) Continuation of application No. PCT/EP2015/061324, filed on May 21, 2015.

(51) Int. Cl. B08B 3/02; A47L 13/26; B05B 12/08; B05B 1/02

(52) U.S. Cl. CPC B08B 3/026; A47L 13/26; A47L 2601/02; B05B 1/02; B08B 2203/0217; B05B 12/08

(57) ABSTRACT

A high-pressure cleaning system with a high-pressure cleaning appliance including a pump, a motor, a pump inlet and a pump outlet, and a control device, and with at least one discharge unit adapted to be brought into fluid connection with the pump outlet for discharging pressurized cleaning liquid is disclosed. In order to further develop the high-pressure cleaning system in such a way that as good a cleaning result as possible is more easily achievable, the high-pressure cleaning system includes a detection unit by which the type of discharge unit presently in fluid connection with the pump outlet is detectable and which is connected in a signal-transmitting manner to the control device, at least one conveying parameter of the high-pressure cleaning appliance being automatically adaptable by the control device to the detected type of discharge unit. A discharge unit for such a high-pressure cleaning system is also disclosed.

### CROSS-REFERENCE TO RELATED APPLICATIONS

This application is a continuation of international application number PCT/EP2015/061324 filed on May 21, 2015, which is incorporated herein by reference in its entirety and for all purposes.

### BACKGROUND OF THE INVENTION

The invention relates to a high-pressure cleaning system with a high-pressure cleaning appliance which comprises a pump and a motor driving the pump as well as a pump inlet for supplying cleaning liquid to be pressurized and a pump outlet for delivering pressurized cleaning liquid and a control device for controlling the high-pressure cleaning appliance, and with at least one discharge unit adapted to be brought into fluid connection with the pump outlet for discharging the pressurized cleaning liquid.

The invention also relates to a discharge unit for such a high-pressure cleaning system, the discharge unit being adapted to be brought into fluid connection with the pump outlet of the high-pressure cleaning appliance for discharging pressurized cleaning liquid.

High-pressure cleaning systems and discharge units of the kind mentioned at the outset are known, for example, from DE 10 2006 009 855 A1. High-pressure cleaning systems comprise a high-pressure cleaning appliance with which a cleaning liquid, for example, water, can be pressurized. For this, the high-pressure cleaning appliances comprise a pump and a motor driving the pump. Cleaning liquid to be pressurized can be supplied to the pump via a pump inlet, and the cleaning liquid pressurized by the pump can be delivered via a pump outlet. Different discharge units can be brought into fluid connection with the pump outlet so that the pressurized cleaning liquid can be directed at a surface to be cleaned by means of the discharge unit in fluid connection with the pump outlet.

Such high-pressure cleaning systems are used for cleaning very different surfaces, for example, for cleaning floor surfaces, building facades and vehicles. Depending on what kind of surface is to be cleaned by means of the high-pressure cleaning system, different discharge units are used. The type of cleaning, for example, rough cleaning, abrasive cleaning or foam cleaning, also influences the choice of the optimal discharge unit that should be brought into fluid connection with the pump outlet of the high-pressure cleaning appliance so as to achieve as good a cleaning result as possible. The discharge units differ from one another by their discharge characteristics, for example, by a different output pressure of the cleaning liquid, a different jet shape or also by the addition of a cleaning chemical that is added to the cleaning liquid.

If, for example, a discharge unit is to be used, with which a cleaning chemical, for example, a soap solution can be added to the pressurized cleaning liquid, then the pressure of the cleaning liquid should be chosen significantly lower than in the case of a discharge unit with which a jet of cleaning liquid that is as spot-shaped as possible for abrasive cleaning is to be directed at a surface. The volume flow of the cleaning liquid should also be adapted to the discharge unit respectively in use so as to achieve as good a cleaning result as possible.

The respective conveying parameters of the high-pressure cleaning appliance that are optimal for different discharge units can often be taken by the user from the operating manual of the high-pressure cleaning appliance. However, the operating manual is often not available to the user when he wants to put the high-pressure cleaning appliance into operation at a site. Also, studying the operating manual is time-consuming. There may, therefore, be cases where the user operates the high-pressure cleaning appliance with a conveying parameter that is not optimally adapted to the discharge unit presently in use and so a good cleaning result cannot be achieved.

The object of the present invention is to further develop a high-pressure cleaning system and a discharge unit of the kind mentioned at the outset in such a way that as good a cleaning result as possible is easily achievable.

### SUMMARY OF THE INVENTION

This object is accomplished, in accordance with the invention, with a high-pressure cleaning system of the generic kind in that the high-pressure cleaning system comprises a detection unit by means of which the type of discharge unit presently in fluid connection with the pump outlet is detectable and which is connected in a signal-transmitting manner to the control device, at least one conveying parameter of the high-pressure cleaning appliance being automatically adaptable by the control device to the detected type of discharge unit.

With the high-pressure cleaning system in accordance with the invention, a good cleaning result can be achieved more easily because at least one conveying parameter of the high-pressure cleaning appliance is automatically adaptable by the control device to the type of discharge unit presently in use. For this purpose, the high-pressure cleaning system comprises a detection unit by means of which the type of discharge unit presently in fluid connection with the pump outlet is detectable. The detection unit is connected in a signal-transmitting manner to the control device of the high-pressure cleaning appliance and so a signal corresponding to the type of discharge unit presently in use can be transmitted by the detection unit to the control device which thereupon automatically adapts at least one conveying parameter of the high-pressure cleaning appliance to the type of discharge unit presently in use. The adaptation may, for example, be carried out by the control device controlling the motor pump unit in such a way that the pump provides a certain output pressure of the cleaning liquid and/or a certain volume flow of the pressurized cleaning liquid. An adaption may also be carried out by an adding device of the high-pressure cleaning appliance being controlled by the control device in order to add a cleaning chemical to the cleaning liquid, with a certain dosage of the cleaning chemical being achieved. The handling of the high-pressure cleaning system in accordance with the invention is, therefore, relatively easy, and yet a very good cleaning result can be achieved without it being necessary for the user to manually enter the optimal conveying parameters of the high-pressure cleaning appliance for the discharge unit presently in use, in order to achieve as good a cleaning result as possible.

In an advantageous embodiment of the high-pressure cleaning system in accordance with the invention, it is expedient for the at least one conveying parameter which is adaptable to the discharge unit presently in use by the control device to include the pressure of the cleaning liquid, the volume flow of the cleaning liquid and/or the dosage of a cleaning chemical addable to the cleaning liquid. In particular, it may be provided that several conveying parameters are automatically adaptable to the discharge unit respectively in use by the control device. For example, when a discharge unit is used by means of which a mixture of cleaning liquid and cleaning chemical can be discharged, both a certain dosage of the cleaning chemical and the pressure of the cleaning liquid and expediently also the volume flow of the cleaning liquid can be automatically adapted by the control device.

The high-pressure cleaning system expediently comprises a display device on which the at least one adapted conveying parameter is displayable to a user. The user, therefore, receives information that is detectable optically, acoustically or in some other way, for example, haptically on the at least one conveying parameter which was automatically adapted to the discharge unit presently in use by the control device.

The at least one adapted conveying parameter is preferably changeable by the user. This makes it possible for the user to manually change the at least one conveying parameter which was adapted by the control device on the basis of the signal provided by the detection unit, if the user is of the opinion that the conveying parameter adapted by the control device could be further optimized for a concrete case in order to solve a certain cleaning task.

In an advantageous embodiment of the invention, the high-pressure cleaning system comprises an input device for inputting at least one conveying parameter.

The input device expediently comprises at least one input element by means of which the user can select and change one of several conveying parameters.

In a particularly preferred configuration of the high-pressure cleaning system in accordance with the invention, the control device comprises a memory in which conveying parameters respectively adapted to one type of discharge unit are stored, and in dependence upon the type of discharge unit presently detected by the detection unit at least one conveying parameter adapted to this type is readable from the memory. Several conveying parameters which are respectively associated with one type of discharge unit are stored in the memory of the control device so as to achieve as good a cleaning result as possible with the respective type of discharge unit. The control device receives from the detection unit a signal corresponding to the presently detected type of discharge unit. Depending on what type is detected, the conveying parameter associated with this presently detected type of discharge unit is then read from the memory, and in accordance with this conveying parameter that has been read, the high-pressure cleaning appliance is then controlled by the control device.

As mentioned above, different discharge units may be used. In a preferred configuration of the invention, the discharge unit is configured as high-pressure flat jet nozzle, high-pressure rotor nozzle, high-pressure spot jet nozzle, low-pressure cleaning agent nozzle, foam nozzle, washing brush or surface cleaner, the surface cleaner having a hood and a nozzle assembly which is movably arranged in the hood and is drivable by the pressurized cleaning liquid. Depending on what type of discharge unit is presently in fluid connection with the pump outlet of the high-pressure cleaning appliance, at least one conveying parameter of the high-pressure cleaning appliance is adapted to this type of discharge unit by the control device.

In an advantageous embodiment of the invention, the discharge unit comprises an identification element which characterizes the type of discharge unit and is detectable in a contact-dependent or contact-free manner by the detection unit. When the discharge unit is brought into flow connection with the pump outlet, the identification element characterizing the type of discharge unit can then be detected by the detection unit, and corresponding information can be transmitted from the detection unit to the control device.

It may be provided that the detection unit detects the identification element in a contact-dependent manner. In such a configuration, mechanical contact occurs between the detection unit and the identification element. Identification elements characterizing different types of discharge units may form different mechanical arrangements which can each be detected by mechanical contacting in the manner of a lock-and-key principle by a detection member of the detection unit.

It is particularly advantageous for the identification element characterizing the type of discharge unit to be detectable in a contact-free manner by the detection unit. In such a configuration, no mechanical contact occurs between the identification element and the detection unit. Instead, a signal characterizing the type of discharge unit is transmitted from the identification element without mechanical contact to the detection unit.

It may, for example, be provided that the identification element is electrically, magnetically, electromagnetically, inductively, capacitively, optically or also mechanically detectable by the detection unit.

In a particularly preferred configuration of the invention, the identification element comprises a memory which is readable by the detection unit. Information characterizing the type of discharge unit may, for example, be stored in the memory and is preferably readable in a contact-free manner by the detection unit.

It is particularly advantageous for at least one conveying parameter adapted to the type of discharge unit to be stored in the memory. With such a configuration of the invention, a conveying parameter adapted to the type of discharge unit can be taken directly from the memory of the identification element. This conveying parameter can be transmitted by the detection unit to the control device which thereupon controls the high-pressure cleaning appliance in accordance with this conveying parameter. Such a configuration has, in particular, the advantage that the control device does not need to keep a large number of conveying parameters available, which are respectively adapted to one type of discharge unit, but rather the control device receives directly from the discharge unit respectively in use via the detection unit the conveying parameter optimally adapted to the discharge unit for achieving as good a cleaning result as possible, on the basis of which the control device can then control the high-pressure cleaning appliance. For example, a certain pressure and/or a certain volume flow and/or a certain dosage of a cleaning chemical, which make it possible to achieve a good cleaning result when the corresponding discharge unit is used, can be stored in the memory of the identification element.

In a particularly preferred configuration of the invention, the identification element is configured as transponder. A transponder is understood as being a radio communication element which receives and responds to incoming signals. Such transponders enable wireless transmission of signals between the identification element and the detection unit, which comprises a reader for wireless communication with the transponder. In addition to a transmitting and receiving antenna, the transponder comprises a memory which is in electrical connection with the transmitting and receiving antenna and can be read by the reader of the detection unit.

It may be provided that the discharge unit can be connected to the pump outlet via a pressure line, for example, a pressure hose, in order to establish a fluid connection.

In an advantageous embodiment of the invention, the high-pressure cleaning system comprises a spray gun with a manually actuatable valve which is arranged in a through-channel extending from a gun inlet to a gun outlet, the gun inlet being adapted to be brought via a pressure line, preferably a pressure hose, into fluid connection with the pump outlet of the high-pressure cleaning appliance, and the discharge unit being connectable to the gun outlet, and the detection unit being arranged on the spray gun. With such a configuration, the fluid connection from the discharge unit to the pump outlet of the high-pressure cleaning appliance is established via a spray gun. The user can manually control the delivery of pressurized cleaning liquid by means of the spray gun. The spray gun has a manually actuatable valve which is arranged in a through-channel extending from a gun inlet to a gun outlet. Pressurized cleaning liquid can be supplied to the gun inlet via a pressure line, for example, a pressure hose, from the high-pressure cleaning appliance. The cleaning liquid flows through the through-channel of the spray gun provided the valve arranged in the through-channel is in its open position. The pressurized cleaning liquid can pass from the gun outlet to the discharge unit, which can be connected to the gun outlet.

Interacting connection members may be arranged at the gun outlet and on the discharge unit. The connection members may, for example, form a bayonet connection.

In addition to the valve controlling the delivery of pressurized cleaning liquid, the spray gun also comprises the detection unit by means of which the discharge unit connected to the spray gun can be detected.

As mentioned above, the detection can be carried out in a contact-dependent or contact-free manner.

It is expedient for an electric device which is connected in a signal-transmitting manner to the detection unit to be arranged on the spray gun. The electric device can receive a signal provided by the detection unit and transmit it to the control device of the high-pressure cleaning appliance. The signal can be transmitted from the electric device to the control device without a line or via a connection line. In particular, radio transmission of signals from the electric device to the control device has proven advantageous.

The electric device of the spray gun expediently comprises an input device for inputting at least one conveying parameter. The input device may, for example, be configured in the form of a keyboard.

The electric device advantageously comprises a display device for displaying at least one conveying parameter. In particular, the conveying parameter adapted to the type of discharge unit presently in use can be displayed on the display device. If this conveying parameter is manually changed by the user, this change can also be displayed on the display device.

It is particularly expedient for the input device and the display device to be constructed as a combined input and output device. The input and output device is preferably configured as touch screen.

The invention also relates to a discharge unit for a high-pressure cleaning system of the kind explained above, with the discharge unit being adapted to be brought into fluid connection with the pump outlet of the high-pressure cleaning appliance for discharging pressurized cleaning liquid. In order to further develop the discharge unit in such a way that as good a cleaning result as possible can be achieved more easily, the discharge unit comprises, in accordance with the invention, an identification element characterizing the type of discharge unit. As explained above, the identification element can be detected by an associated detection unit, and a signal corresponding to the type of detected discharge unit can be transmitted from the detection unit to the control device of the high-pressure cleaning appliance so that at least one conveying parameter of the high-pressure cleaning appliance can be adapted to the type of discharge unit.

The identification element is expediently detectable electrically, magnetically, electromagnetically, inductively, capacitively, optically or mechanically.

The identification element preferably comprises a memory. The memory can be read in a contact-dependent or contact-free manner by a detection unit, and information characterizing the type of discharge unit can be stored in the memory.

It may be provided that at least one conveying parameter adapted to the type of discharge unit is stored in the memory. As explained above, this makes it possible to store in the memory at least one conveying parameter which, in order to achieve as good a cleaning result as possible, is optimally adapted to the respective discharge unit. This conveying parameter can be read by a detection unit and made available to the control device of the high-pressure cleaning appliance so that the control device can control the high-pressure cleaning appliance in such a way that the high-pressure cleaning appliance provides the conveying parameter that is optimally adapted to the discharge unit.

In a particularly preferred configuration of the invention, the identification element is configured as transponder. As mentioned above, a transponder is a radio communication element which receives and responds to incoming signals. The incoming signals are provided by the detection unit, and the outgoing signals are received by the detection unit. The transponder may have a power supply device of its own, for example, a battery. It is, however, particularly expedient for the transponder to be supplied with power by the detection unit. For example, the detection unit can transmit to the transponder an electromagnetic signal, which results in an electric voltage being induced in the transponder. Such transponders are known per se to one skilled in the art and in this case require no further explanation.

The discharge unit in accordance with the invention is advantageously configured as high-pressure flat jet nozzle, high-pressure rotor nozzle, high-pressure spot jet nozzle, low-pressure cleaning agent nozzle, foam nozzle, washing brush or surface cleaner, with the latter having a hood in which a nozzle assembly, which is drivable by pressurized cleaning liquid, is movably arranged.

It is particularly advantageous for the discharge unit to comprise a mechanical connection member which is mechanically connectable, in particular, connectable by plugging-in, to a spray gun, the identification element being integrated in the connection member. The connection member may, for example, comprise a connection plug which can be inserted into a complementarily configured connection receptacle of the spray gun, and the identification element can be integrated in the connection plug. The identification element may, for example, be configured in the form of a transponder, and a detection unit of the spray gun associated with the identification element may, for example, comprise a reader which is associated with the transponder and is arranged adjacent to the connection receptacle of the spray gun receiving the connection plug. The reader may, for example, be integrated in a wall of the connection receptacle. The reader can be connected to an electric device of the spray gun via an electric connection line, the electric device comprising a power supply unit with which the reader can be supplied with electric power. The power supply unit may, for example, be in the form of a battery, in particular, a rechargeable battery.

The following description of a preferred embodiment of the invention will serve in conjunction with the drawings to explain the invention in greater detail.

### BRIEF DESCRIPTION OF THE DRAWINGS

FIG. 1 is a perspective representation of a high-pressure cleaning system with a high-pressure cleaning appliance which is connected by a pressure line to a spray gun to which various discharge devices can be connected;

FIG. 2 is a perspective representation of a further discharge unit which can be alternatively connected to the spray gun from FIG. 1;

FIG. 3 is a schematic view of the discharge unit from FIG. 2 from below; and

FIG. 4 is a schematic block diagram of the high-pressure cleaning system from FIG. 1.

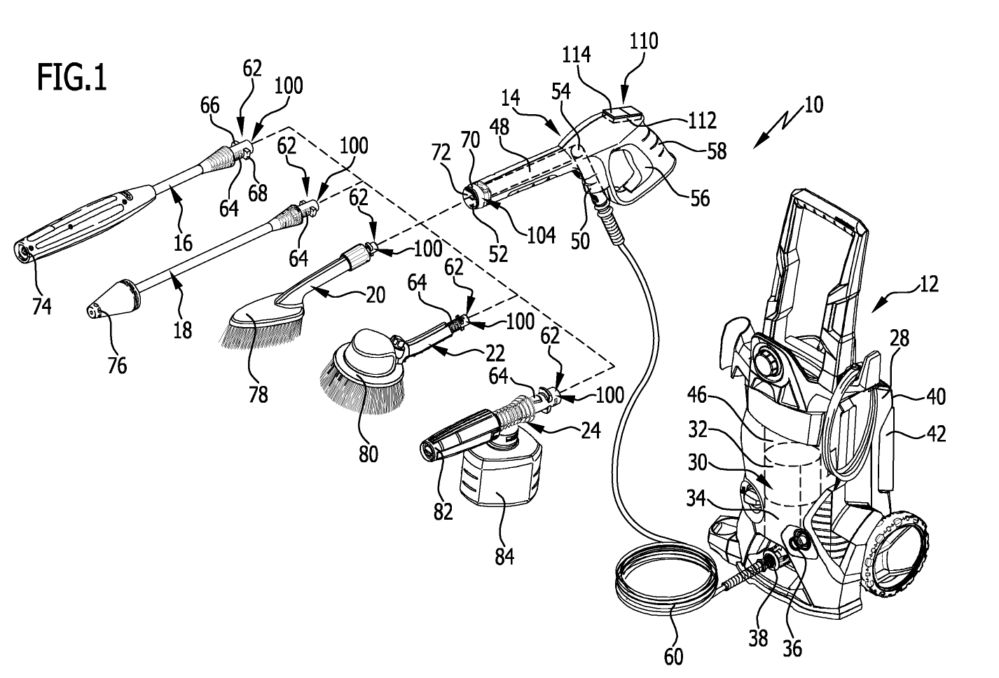

### DETAILED DESCRIPTION OF THE INVENTION

An advantageous embodiment of a high-pressure cleaning system is shown schematically and denoted in its entirety by reference numeral 10 in the drawings. The high-pressure cleaning system 10 comprises a high-pressure cleaning appliance 12 and a spray gun 14 and several discharge units 16, 18, 20, 22, 24 and 26 which can be selectively connected to the spray gun 14.

The high-pressure cleaning appliance 12 comprises a housing 28 in which a motor-pump unit 30 with a drive motor 32 and with a pump 34 is arranged. Cleaning liquid to be pressurized, preferably water, can be supplied to the pump 34 via a pump inlet 36, and cleaning liquid which has been pressurized by the pump 34 can be delivered via a pump outlet 38.

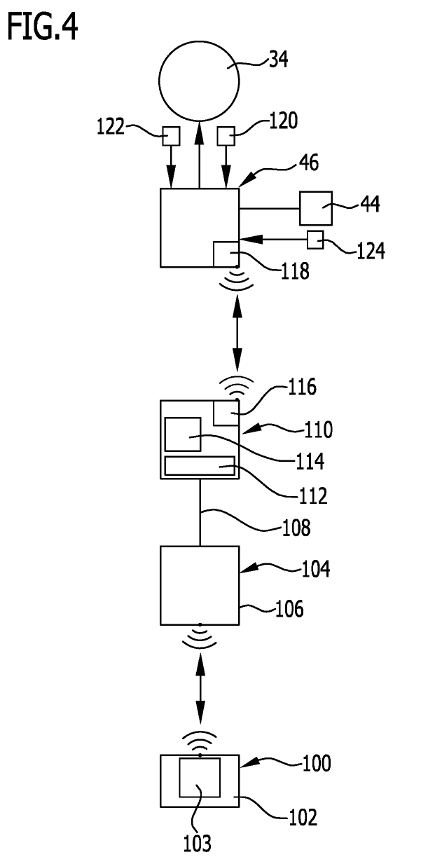

A container 42 in which a cleaning chemical is stored is releasably held on a rear side 40 of the housing 28. The cleaning chemical can be added in a dosed manner to the pressurized cleaning liquid by means of an adding device 44 shown schematically in FIG. 4.

The high-pressure cleaning appliance 12 is controlled by means of a control device 46 which is likewise arranged in the housing 28.

The spray gun 14 comprises a through-channel 48 which extends from a gun inlet 50 to a gun outlet 52 and in which a valve 54 is arranged. For actuating the valve 54, the spray gun 14 has a trigger 56 which is pivotably arranged on a handle 58 of the spray gun 14 and can be manually actuated by the user in order to open and close the valve 54.

The gun inlet 50 is in flow connection with the pump outlet 38 via a pressure line, in the illustrated embodiment via a pressure hose 60, so that cleaning liquid which has been pressurized by the high-pressure cleaning appliance 12 can be supplied to the spray gun 14.

One of the discharge units 16, 18, 20, 22, 24 and 26 in accordance with the user's choice can be connected to the gun outlet 52 of the spray gun 14. Which discharge unit is used depends on which kind of surface is to be cleaned by means of the high-pressure cleaning system 10. The discharge units 16, 18, 20, 22, 24 and 26 can be brought into fluid connection with the pump outlet 38 via the spray gun 14, so that pressurized liquid can be directed at a surface to be cleaned via the discharge unit respectively connected to the spray gun 14. The output of cleaning liquid can be controlled by the user by means of the valve 54.

To establish a mechanical connection and a fluid connection with the spray gun 14, the discharge units 16, 18, 20, 22, 24, 26 each comprise a connection member 62 with a connection plug 64 and with two bayonet wings 66, 68. The connection member 62 interacts in a positively locking manner with a connection member 70 of complementary configuration of the spray gun 14. For this purpose, the connection member 70 comprises a connection receptacle 72 into which the connection plug 64 can be inserted. In addition, the connection member 70 comprises bayonet recesses which interact with the bayonet wings 66, 68 in a closed position. Such bayonet recesses are known per se to one skilled in the art and are, therefore, not shown in the drawings in order to achieve a better overview.

The discharge unit 16 comprises a high-pressure flat jet nozzle 74 which is known per se to one skilled in the art and is, therefore, shown only schematically in the drawings. A fan-shaped high-pressure jet can be discharged by means of the high-pressure flat jet nozzle 74.

The discharge unit 18 comprises a high-pressure rotor nozzle 76 with which a spot jet circulating on a conical shell can be generated. Such high-pressure rotor nozzles 76 are known per se to one skilled in the art and, in the present case, do, therefore, not require any further explanation either.

The discharge unit 20 comprises a first washing brush 78, and the discharge unit 22 comprises a second washing brush 80. The two washing brushes 78 and 80 differ from each other with respect to their shape and function.

The discharge unit 24 comprises a foam nozzle 82 and a discharge container 84 in which a foam-forming chemical can be stored. The foam-forming chemical can be added to the cleaning liquid provided by the high-pressure cleaning appliance 12 via the spray gun 14, so that a cleaning agent foam can be discharged.

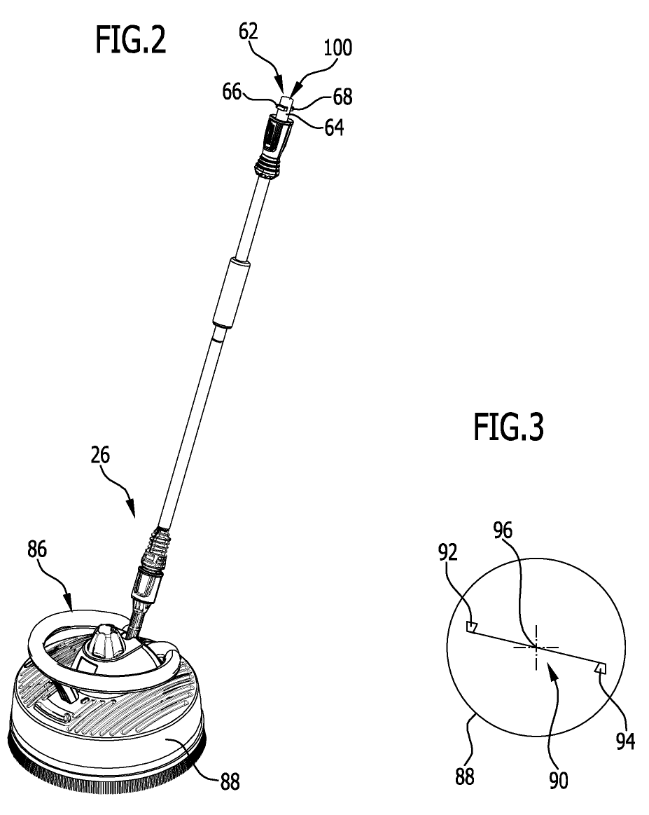

The discharge unit 26 is shown schematically in FIGS. 2 and 3. This discharge unit 26 also comprises a connection member 62, as was already explained hereinabove, and can be connected to the spray gun 14 and, consequently, brought into fluid connection with the pump outlet 38. The discharge unit 26 is configured in the form of a surface cleaner 86 comprising a hood 88. A nozzle assembly 90 with a first outlet nozzle 92 and a second outlet nozzle 94 is held in the hood 88 so as to be rotatable about a common axis of rotation 96. Under the action of the cleaning liquid, the nozzle assembly 90 is set in rotation about the axis of rotation 96 and the supplied cleaning liquid can be applied via the outlet nozzles 92 and 94 to a surface to be cleaned, preferably a floor surface.

Depending on the kind and structure of the surface to be cleaned and also on the type of cleaning desired, for example, rough cleaning, abrasive cleaning, foam cleaning, brush cleaning, the user can selectively connect one of the discharge units 16, 18, 20, 22, 24, 26 to the spray gun 14 and apply cleaning liquid to the surface to be cleaned. If necessary, a cleaning chemical from the container 42 or a foam-forming chemical from the discharge container 84 can be added to the cleaning liquid.

As good a cleaning result as possible should, of course, be achieved for each of the discharge units 16, 18, 20, 22, 24, 26, and damage to the surface to be cleaned should naturally be avoided.

To achieve as good a cleaning result as possible with the discharge units 16, 18, 20, 22, 24, 26, it is necessary to adapt at least one conveying parameter of the high-pressure cleaning appliance 12 to the discharge unit respectively in use. This adaptation takes place automatically in the high-pressure cleaning system 10. For this purpose, each discharge unit 16, 18, 20, 22, 24, 26 has an identification element 100 which characterizes the type of the respective discharge unit 16, 18, 20, 22, 24, 26 and in the illustrated embodiment is configured as transponder 102. In the illustrated embodiment, the transponder 102 is integrated in the connection member 62, more particularly, in the connection plug 64, which can be inserted into the connection receptacle 72 of the spray gun 14.

The spray gun 14 comprises a detection unit 104 which is associated with the identification element 100 and by means of which the type of discharge unit 16, 18, 20, 22, 24, 26 that is respectively connected can be detected. In the illustrated embodiment, the detection unit 104 is configured as reader 106 with which a memory 103, shown schematically in FIG. 4, of the transponder 102 can be read in a contact-free manner. In the illustrated embodiment, the reader 106 is arranged in a wall of the connection receptacle 72 so that the transponder 102 of the discharge unit 16, 18, 20, 22, 24, 26 respectively connected to the spray gun 14 can be positioned at as short a distance as possible from the reader 106.

The reader 106 is in electrical connection via an electric connection line 108 with an electric device 110 of the spray gun 14. A signal characterizing the respectively detected type of discharge unit 16, 18, 20, 22, 24, 26 can be transmitted to the electric device 110 via the electric connection line 108. The electric device 110 comprises a power supply unit in the form of a battery 112 and a combined input-output device in the form of a touch screen 114 by means of which at least one conveying parameter of the high-pressure cleaning appliance 12 can be displayed to the user, and the user can manually change at least one conveying parameter of the high-pressure cleaning appliance 12.

The electric device 110 comprises a first radio member 116 and the control device 46 comprises a second radio member 118 so that signals can be wirelessly transmitted between the electric device 110 and the control device 46 via the radio members 116, 118. This makes it possible to transmit a control signal characterizing the type of discharge unit 16, 18, 20, 22, 24, 26 presently connected to the spray gun 14 from the electric device 110 to the control device 46, and a conveying parameter can be transmitted to the electric device 110 from the control device 46, which can then be displayed on the touch screen 114.

If the conveying parameter is changed by the user on the touch screen 114, the changed conveying parameter can also be transmitted from the electric device 110 to the control device 46.

The control device 46 automatically adapts at least one conveying parameter of the high-pressure cleaning appliance 12 to the discharge unit 16, 18, 20, 22, 24, 26 respectively in use. In particular, the pressure of the cleaning liquid prevailing at the pump outlet 38, the volume flow of the cleaning liquid flowing through the pump outlet 38 and the dosage of the cleaning chemical addable by means of the adding device 44 to the cleaning liquid are used as conveying parameters. In order to achieve as good a cleaning result as possible, these conveying parameters can be automatically adapted to the discharge unit 16, 18, 20, 22, 24, 26 respectively in use. In the illustrated embodiment, the respective optimal conveying parameters for the respective discharge unit are stored for this purpose in the memory 103 of the transponders 102 of the discharge units 16, 18, 20, 22, 24, 26, and when the respective discharge unit is connected to the spray gun 14, the conveying parameter stored in the memory can be read by means of the reader 106. A corresponding signal can then be transmitted from the reader 106 via the connection line 108 to the electric device 110 and from it via the radio connection to the control device 46. The control device 46 then controls the high-pressure cleaning appliance 12 in such a way that the respectively read conveying parameter is provided. For this purpose, the high-pressure cleaning appliance 12 comprises a pressure sensor 120 by means of which the pressure of the cleaning liquid prevailing at the pump outlet 38 can be detected, and the high-pressure cleaning appliance 12 comprises a volume flow sensor 122 by means of which the volume flow of the cleaning liquid flowing through the pump outlet 38 can be detected. In addition, the high-pressure cleaning appliance 12 comprises a concentration sensor 124 by means of which the concentration of the cleaning chemical which may have been added to the cleaning liquid by means of the adding device 44 can be detected. The pressure sensor 120 as well as the volume flow sensor 122 and the concentration sensor 124 are in electrical connection with the control device 46, and the control device controls the pump 34 and the adding device 44 in a such a way that the conveying parameters provided by the detection unit 104, which, in order to achieve as good a cleaning result as possible, are adapted to the discharge unit 16, 18, 20, 22, 24, 26 respectively in use, are provided by the high-pressure cleaning appliance 12.

Operation of the high-pressure cleaning system 10 is, therefore, very easy for the user. Depending on the cleaning task to be solved, different discharge units 16, 18, 20, 22, 24, 26 can be used, and the conveying parameters of the high-pressure cleaning appliance 12 are automatically adapted to the discharge unit respectively in use without the user having to perform complicated settings on the high-pressure cleaning appliance 12 or on the spray gun 14 for this. In spite of the automatic adaptation of the conveying parameters to the discharge unit respectively in use, it is, if required, possible for the user to change the conveying parameters on the touch screen 114 of the spray gun 14.

1. A high-pressure cleaning system with a high-pressure cleaning appliance which comprises a pump and a motor driving the pump as well as a pump inlet for supplying cleaning liquid to be pressurized and a pump outlet for delivering pressurized cleaning liquid and a control device for controlling the high-pressure cleaning appliance, and with at least one discharge unit adapted to be brought into fluid connection with the pump outlet for discharging the pressurized cleaning liquid, wherein the high-pressure cleaning system comprises a detection unit by means of which the type of discharge unit presently in fluid connection with the pump outlet is detectable and which is connected in a signal-transmitting manner to the control device, at least one conveying parameter of the high-pressure cleaning appliance being automatically adaptable by the control device to the detected type of discharge unit.

2. The high-pressure cleaning system in accordance with claim 1, wherein the at least one adaptable conveying parameter includes at least one of the pressure of the cleaning liquid, the volume flow of the cleaning liquid and a dosage of a cleaning chemical addable to the cleaning liquid.

3. The high-pressure cleaning system in accordance with claim 1, wherein the high-pressure cleaning system comprises a display device on which the at least one adapted conveying parameter is displayable to a user.

4. The high-pressure cleaning system in accordance with claim 1, wherein the at least one adaptable conveying parameter is changeable by the user.

5. The high-pressure cleaning system in accordance with claim 4, wherein the high-pressure cleaning system comprises an input device for inputting at least one conveying parameter.

6. The high-pressure cleaning system in accordance with claim 1, wherein the control device comprises a memory in which conveying parameters respectively adapted to one type of discharge unit are stored, and in dependence upon the type of discharge unit presently detected by the detection unit at least one conveying parameter adapted to this type is readable from the memory.

7. The high-pressure cleaning system in accordance with claim 1, wherein the at least one discharge unit is configured as high-pressure flat jet nozzle, high-pressure rotor nozzle, high-pressure spot jet nozzle, low-pressure cleaning agent nozzle, foam nozzle, washing brush or surface cleaner, the surface cleaner having a hood and a nozzle assembly which is movably arranged in the hood and is drivable by pressurized cleaning liquid.

8. The high-pressure cleaning system in accordance with claim 1, wherein the at least one discharge unit comprises an identification element which characterizes the type of discharge unit and is detectable in a contact-dependent or contact-free manner by the detection unit.

9. The high-pressure cleaning system in accordance with claim 8, wherein the identification element is electrically, magnetically, electromagnetically, inductively, capacitively, optically or mechanically detectable by the detection unit.

10. The high-pressure cleaning system in accordance with claim 8, wherein the identification element comprises a memory which is readable by the detection unit.

11. The high-pressure cleaning system in accordance with claim 10, wherein at least one conveying parameter adapted to the type of the at least one discharge unit is stored in the memory.

12. The high-pressure cleaning system in accordance with claim 8, wherein the identification element is configured as transponder.

13. The high-pressure cleaning system in accordance with claim 1, wherein the high-pressure cleaning system comprises a spray gun with a manually actuatable valve which is arranged in a through-channel extending from a gun inlet to a gun outlet, the gun inlet being adapted to be brought via a pressure line into fluid connection with the pump outlet, and the at least one discharge unit being connectable to the gun outlet, and the detection unit being arranged on the spray gun.

14. The high-pressure cleaning system in accordance with claim 13, wherein an electric device which is connected in a signal-transmitting manner to the detection unit is arranged on the spray gun.

15. The high-pressure cleaning system in accordance with claim 14, wherein the electric device comprises an input device for inputting at least one conveying parameter.

16. The high-pressure cleaning system in accordance with claim 14, wherein the electric device comprises a display device for displaying at least one conveying parameter.

17. A discharge unit for a high-pressure cleaning system in accordance with claim 1, the discharge unit being adapted to be brought into fluid connection with the pump outlet of the high-pressure cleaning appliance for discharging pressurized cleaning liquid, and the discharge unit comprising an identification element characterizing the type of discharge unit.

18. The discharge unit in accordance with claim 17, wherein the identification element is electrically, magnetically, electromagnetically, inductively, capacitively, optically or mechanically detectable.

19. The discharge unit in accordance with claim 17, wherein the identification element comprises a memory.

20. The discharge unit in accordance with claim 17, wherein the identification element is configured as transponder.

21. The discharge unit in accordance with claim 17, the discharge unit being configured as high-pressure flat jet nozzle, high-pressure rotor nozzle, high-pressure spot jet nozzle, low-pressure cleaning agent nozzle, foam nozzle, washing brush or as surface cleaner, the surface cleaner having a hood and a nozzle assembly which is movably arranged in the hood and is drivable by pressurized cleaning liquid.

22. The discharge unit in accordance with claim 17, the discharge unit comprising a mechanical connection member which is mechanically connectable, in particular, connectable by plugging-in, to a spray gun, the identification element being integrated in the connection member.
